(19) United States
(12) Patent Application Publication
(10) Pub. No.: US 2025/0258886 A1
(43) Pub. Date: Aug. 14, 2025

(54) SYSTEMS AND METHOD FOR SOLVING SPIN GLASSES AND OTHER SPARSE ISING PROBLEMS

(71) Applicant: NORTHROP GRUMMAN SYSTEMS CORPORATION, FALLS CHURCH, VA (US)

(72) Inventor: KENNETH M. ZICK, ARLINGTON, VA (US)

(21) Appl. No.: 18/437,344

(22) Filed: Feb. 9, 2024

(51) Int. Cl. G06F 17/11

(52) U.S. Cl. CPC G06F 17/11

(57) ABSTRACT

A dynamical Ising solver system can efficiently generate high-quality solutions to binary optimization problems. A problem description is received indicating a graph of binary variables and weighted couplings between them. An edge coloring of the graph is used to select sub-neighborhoods of a relaxed problem involving continuous variables, where variables connected to edges of a given edge color are updated by adjusting continuous variables on edges of that color toward or away from each other based on a step size and their coupling. Dual phase window shifts are employed to stochastically alter the continuous variables to avoid the system being trapped in saddle points or local minima. The final values of the continuous variables are used to determine binary values of a solution for the binary optimization problem.

### TECHNICAL FIELD

This description relates to a system that efficiently generates high quality solutions of sparse Ising problems.

### BACKGROUND

Binary optimization problems with quadratic interactions and a sparse problem structure have long been important in condensed matter and statistical physics, and also have potential roles in defense and commercial industry. For instance, independent set problems on spatial networks (geometric graphs) can arise in maximization of airspace, strategic placement of resources, and network design. A canonical example of a sparse quadratic binary optimization problem is finding low energy configurations of an Edwards-Anderson Ising spin glass, where spins exist in a lattice with regular connectivity and a random mix of attractive (ferromagnetic) and repulsive (anti-ferromagnetic) interactions. Due to disorder and frustration, spin glass-like problems can be difficult to solve with high efficiency and accuracy. Another example of a sparse Ising problem is one with a sparse random structure.

### SUMMARY

A first example relates to a non-transitory machine-readable medium having machine executable instructions for a dynamical Ising solver that cause a processor core to execute operations. The operations include receiving a problem graph that includes a set of binary variables connected by a set of edges, a set of weights associated with the set of edges, and an edge coloring of the set of edges that indicates an edge color of a set of edge colors for an edge of the set of edges. The edge of the set of edges corresponds to a pairwise coupling between the binary variables connected by the edge. A weight of the set of weights indicates a coupling strength of the edge of the set of edges. The binary variable of the set of binary variables is connected to at most one edge of the set of edges with the edge color of the set of edge colors. The operations also include generating a set of continuous variables. A continuous variable of the set of continuous variables corresponds to the binary variable of the set of binary variables. The operations additionally include setting a current step size to an initial step size and a current value of the continuous variable of the set of continuous variables to a random initial value. The operations further include performing a sweep of a set of sweeps. The sweep includes updating a subset of the set of edges. The subset includes edges with a given edge color. Updating the subset of the set of edges includes, for a given edge of the subset, adjusting the current values of the continuous variables connected to the given edge based on a minimum phase difference between the current values, the current step size, and the coupling strength of the given edge. The sweep also includes performing a dual phase window shift on the set of continuous variables and updating the current step size based on a step size schedule. Additionally, the operations include generating a binary solution for the problem graph and the set of weights. The binary solution includes a set of final values for the set of binary variables based on the current values of the set of continuous variables.

A second example relates to a dynamical Ising solver system including a memory for storing machine-readable instructions and a processor core for accessing the machine-readable instructions and executing the machine-readable instructions as operations. The operations include receiving a problem graph that includes a set of binary variables connected by a set of edges, a set of weights associated with the set of edges, and an edge coloring of the set of edges that indicates an edge color of a set of edge colors for an edge of the set of edges. The edge of the set of edges corresponds to a pairwise coupling between the binary variables connected by the edge. A weight of the set of weights indicates a coupling strength of the edge of the set of edges. The binary variable of the set of binary variables is connected to at most one edge of the set of edges with the edge color of the set of edge colors. The operations also include generating a set of continuous variables. A continuous variable of the set of continuous variables corresponds to the binary variable of the set of binary variables. The operations additionally include setting a current step size to an initial step size and a current value of the continuous variable of the set of continuous variables to a random initial value. The operations further include performing a sweep of a set of sweeps. The sweep includes updating a subset of the set of edges. The subset includes edges with a given edge color. Updating the subset of the set of edges includes, for a given edge of the subset, adjusting the current values of the continuous variables connected to the given edge based on a minimum phase difference between the current values, the current step size, and the coupling strength of the given edge. The sweep also includes performing a dual phase window shift on the set of continuous variables and updating the current step size based on a step size schedule. Additionally, the operations include generating a binary solution for the problem graph and the set of weights. The binary solution includes a set of final values for the set of binary variables based on the current values of the set of continuous variables.

A third example relates to a method for dynamically solving Ising problems. The method includes receiving a problem graph that includes a set of binary variables connected by a set of edges, a set of weights associated with the set of edges, and an edge coloring of the set of edges that indicates an edge color of a set of edge colors for an edge of the set of edges. The edge of the set of edges corresponds to a pairwise coupling between the binary variables connected by the edge. A weight of the set of weights indicates a coupling strength of the edge of the set of edges. The binary variable of the set of binary variables is connected to at most one edge of the set of edges with the edge color of the set of edge colors. The method also includes generating a set of continuous variables. A continuous variable of the set of continuous variables corresponds to the binary variable of the set of binary variables. The method additionally includes setting a current step size to an initial step size and a current value of the continuous variable of the set of continuous variables to a random initial value. The method further includes performing a sweep of a set of sweeps. The sweep includes updating a subset of the set of edges. The subset includes edges with a given edge color. Updating the subset of the set of edges includes, for a given edge of the subset, adjusting the current values of the continuous variables connected to the given edge based on a minimum phase difference between the current values, the current step size, and the coupling strength of the given edge. The sweep also includes performing a cluster flip on the set of continuous variables and updating the current step size based on a step size schedule. Additionally, the method includes generating a binary solution for the problem graph and the set of weights. The binary solution includes a set of final values for the set of binary variables based on the current values of the set of continuous variables.

### BRIEF DESCRIPTION OF THE DRAWINGS

FIG. 1 illustrates an example of a computing environment for a dynamical Ising solver system.

FIG. 2 illustrates a toroidal square grid graph shown as a square grid with periodic boundaries in both dimensions and as a torus in a three-dimensional space.

FIG. 3 illustrates a diagram showing a periodic interval represented as a ring, with individual variables represented as black circles on the ring.

FIG. 4 illustrates a graph of the coupling energy as a function of angular difference for a pair of ferromagnetically coupled variables and a graph of the coupling function as a function of angular difference.

FIG. 5 illustrates an example edge coloring of a square grid with colors 1, 2, 3, and 4 along with the corresponding sub-neighborhoods for sequential updates.

FIG. 6 illustrates a series of four images showing example dynamics of the collective switched motion (Cosm) solver discovering an extremely low-energy configuration through a polarized cluster flip.

FIG. 7 illustrates three images showing a dual phase window shift used in some example systems and methods to facilitate polarized cluster flips.

FIG. 8 illustrates an example of the energy evolution of a Cosm run as a function of sweep number.

FIG. 9 illustrates a table of solver speed compared to a leading conventional solver.

FIG. 10 illustrates a table of solution quality for the prototype compared to two leading conventional solvers for the seven largest sparse Gset MaxCut benchmark problems.

FIG. 11 illustrates a solution bitstring for the Gset G72 problem generated by the prototype with a cut value (7008) higher than the best-known cuts (7006).

FIG. 12 illustrates the spatial layout of four large cluster flips responsible for reaching the new best-known cut in four prototype runs.

FIG. 13 illustrates a flowchart of an example method for using a dynamical Ising solver system to efficiently generate high-quality solutions of binary optimization problems.

### DETAILED DESCRIPTION

The systems and methods described herein provide a fast, simple dynamical solver approach for combinatorial optimization problems (e.g., Ising problems, etc.) referred to herein as collective switched motion (Cosm). Cosm is based on a relaxation of the Ising problem designed from the ground up and employs a discrete dynamical systems solver using bang-bang interactions between coupled spin variables and additional techniques discussed herein for handling sparse Ising problems. Cosm stimulates the emergence of large spin clusters that flip and drive the system toward hard-to-reach energies. Systems and methods employing Cosm provide techniques for determining fast, high-quality solutions of combinatorial optimization problems such as low energy states of spin glasses, as well as other problems in a range of fields that are convertible to such problems. Systems and methods employing the Cosm dynamical solver provide significant improvements in the functioning of computing systems for solving combinatorial optimization problems compared to conventional techniques, as described in greater detail below.

A prototype system was applied to a set of specialized benchmark problems that have been attacked since the year 2000 and the system exhibited unprecedented heuristic performance. On two problems the prototype reached higher solution quality than ever recorded by any previous heuristic solver, in part due to the facilitated emergent cluster flips. The prototype was compared to three conventional solvers with leading time-to-solution results on this test set (Toshiba's Simulated Bifurcation Machine, Fujitsu's Digital Annealer, and Breakout Local Search) and exhibited performance that improves dramatically with size relative to the conventional solvers, consistent with better algorithmic scaling. Systems and methods discussed herein are employable as all-digital accelerators specialized for combinatorial optimization problems such as sparse Ising problems, significantly improving the function and performance of the computing system employing the accelerator for solving combinatorial optimization problems (e.g., Ising or quadratic unconstrained binary optimization (QUBO) problems). Such problems arise in logistics, communications, statistical mechanics, infrastructure (transportation, power, water, communications), multi-vehicle systems, biology (protein networks, neural networks, etc.), training of deep Boltzmann networks, and other domains with binary quadratic interactions on spatial networks.

Systems and methods discussed herein employ algorithms that specify a dynamical system of simulated spin variables that collectively use a sequence of gradients of the energy landscape to find extremely low-energy configurations. These configurations correspond to extremely high-quality solutions to the Ising problem being solved (and a corresponding solution to the real-world problem modeled as the Ising problem).

In some examples, an algorithm first maps the binary variables of the input problem to periodic continuous spin variables (referred to as a continuous relaxation) and initializes the spins to random values. In example systems and methods, each continuous variable can take on one of many possible values; it is understood that in practice the number of possible values is finite and determined by the variable representation on the computer environment. The input graph is split into subsets (e.g., based on edge colors); for instance, a square grid graph is split into four subsets representing an edge coloring with 4 colors. The example algorithm then evaluates the pairwise couplings (edges) of a given subset by comparing the values of each pair of spins. Each variable is updated by no more than one interaction for a given subset of edges, thereby avoiding conflicts. Each pair of spins decides among just two possible options (a type of bang-bang control), either to move in the direction toward or away from the neighboring spin value. Due to the edge coloring, the interactions associated with a given edge color are independent and can be handled in parallel. Collectively the spin system estimates the gradient of the continuous energy function defined by a specified energy function and by the dynamic network formed by the edges of the current color. The spins move in the direction opposite from the gradient associated with this color. The input for the example algorithm is the problem graph (along with weights) and an edge coloring of the graph. In some scenarios, the same pre-computed edge coloring can be reused by many examples, such as when the problem graphs of those examples all have the same lattice structure. In other examples (such as sparse random graphs) where a unique edge coloring is used for a given problem, a sufficient edge coloring is generatable by one of several polynomial-time heuristics (e.g., by using the Misra & Gries edge coloring algorithm to produce an edge coloring within at most one color of optimal, etc.). Prototype testing found no noticeable drop in efficiency with sub-optimal edge colorings within two to three colors of optimal. The algorithm loops over all subsets (edge colors) and then repeats. This model and its associated dynamics are referred to herein as “collective switched motion” or “Cosm.”

Along with the edge-colored updates, a perturbation type referred to herein as a dual phase window shift (DPWS) (applied at periodic or stochastic intervals) helps the solver escape from saddle points and low-energy “traps” (local energy minima) in the search landscape. In various examples of a dual phase window shift, the unit circle defining the interval of all spin variables is split into four windows, and two of the windows (slices) on opposite sides (e.g., with width of around 90 degrees, such as 70-110 degrees) are then shifted by the same amount (e.g., less than 90 degrees, such as less than or equal to 45 degrees), such as by rotating those windows clockwise or counterclockwise (while references to a range from −180 to 180, 0 to 360, or degrees are discussed herein for ease of illustration, other periodic ranges of continuous variables are used in some examples and are readily convertible to or from these example ranges). Any spin variable whose value was in one of those windows is shifted by an identical amount. This allows variables to free up and get a clearer view of where they stand relative to each of their neighbors. Groups of shifted variables are then able to better sense the true gradient of the search space defined by the current network (the colored edge subset) and make a useful move toward lower energy. DPWS allows the system of spin variables to move away from non-optimal stationary points (such as saddle points or poor local minima) and differs from other forms of perturbation such as applying random noise to each spin. With DPWS, many of the previously determined relationships between spins (e.g., spin pairs that have fallen into close alignment or close anti-alignment) are maintained. Results from prototype testing showed that DPWS enables large clusters of variables to emerge and move to opposite sides, allowing the system to reach very low energies and often the ground state.

The combination of Cosm with polarized cluster flips (e.g., via DPWS) provides high quality solutions with efficiency that scales better than conventional solvers and acts as a form of perturbed sequenced gradient descent. In some examples, a step size used in sweeps of the edge colors is dynamically decreased (e.g., linearly or non-linearly) from a high initial value to a small final value. The global step size is a factor that scales the size of the variable moves due to coupling interactions, local field interactions, and dual-phase window shift perturbations. Simulations in connection with a prototype showed that a linearly decreasing ramp over the span of the algorithm run is an effective step size schedule. This schedule helps ensure that the system energy tends to be lowest at the very end of the algorithm with high probability, so the final system configuration is generally sufficient, unlike many conventional algorithms that involve reading out and evaluating many intermediate configurations in search of the lowest energy.

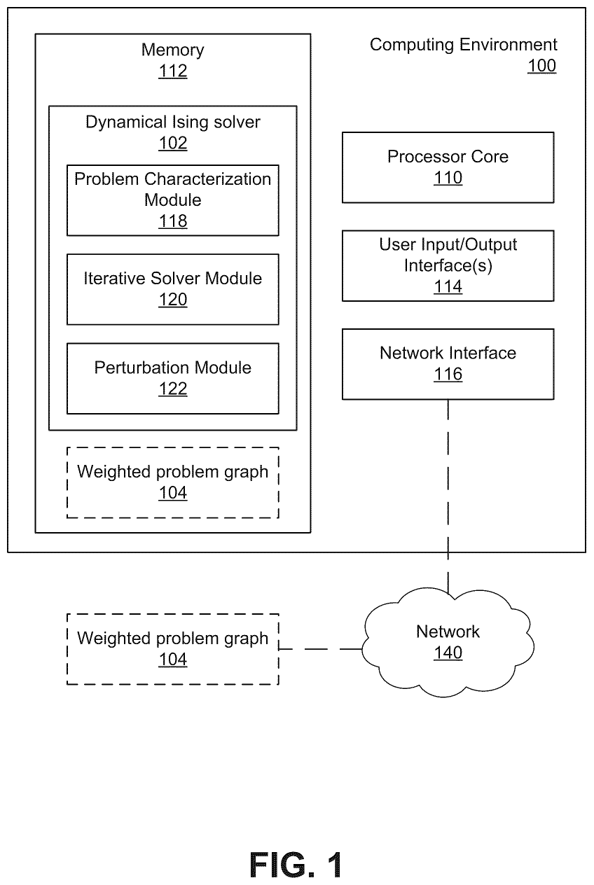

FIG. 1 illustrates an example computing environment 100 implementing a dynamical Ising solver 102 capable of efficiently generating high-quality solutions to combinatorial optimization problems such as Ising problems, QUBO problems, and their equivalents. Dynamical Ising solver 102 receives a weighted problem graph 104 that includes a problem graph and associated weights. In some examples, weighted problem graph 104 is generated to represent an equivalent problem (e.g., in logistics, communications, statistical mechanics, etc.) as a combinatorial optimization problem.

Computing environment 100 includes a processor core 110, a memory 112, a user input/output (I/O) interface 114, and a network interface 116, which are operably connected for computer communication. The processor core 110 performs general computing to execute instructions stored in the memory 112, including instructions associated with dynamical Ising solver 102. The instructions cause the processor core 110 to execute operations. The memory 112 also stores instructions associated with an operating system that controls and/or allocates resources of computing environment 100, including resources associated with dynamical Ising solver 102. In some scenarios, the memory 112 stores weighted problem graph 104 locally, while in other scenarios weighted problem graph 104 is stored remotely, and in further scenarios weighted problem graph 104 is stored partially locally and partially remotely. Memory 112 represents a non-transitory machine-readable memory (or other medium), such as random access memory (RAM), a solid state drive, a hard disk drive or a combination thereof.

Dynamical Ising solver 102 includes a problem characterization module 118, an iterative solver module 120, and a perturbation module 122. Memory 112 stores machine-readable instructions associated with modules 118-122.

Processor core 110 accesses memory 112 and executes the machine-readable instructions as operations. Processor core 110 can be a variety of various processors including multiple single- and multi-core processors, co-processors, and other multiple single and multicore processor and co-processor architectures. Examples include a CPU, a GPU, FPGA, ASIC or other highly parallel processor.

User I/O interface 114 provides software and hardware to facilitate data input and output between computing environment 100 and a user. This can include input devices such as a keyboard, mouse, touchpad, touchscreen, microphone, etc., as well as output devices such as display(s) (e.g., light-emitting diode (LED) display panel(s), liquid crystal display (LCD) panel(s), plasma display panel(s), and/or touch screen display(s), etc.), speaker(s), etc. User I/O interface 114 provides graphical input controls for a user interface, which can include software and hardware-based controls, interfaces, touch screens, or touch pads or plug and play devices for a user to provide user input.

Network interface 116 provides software and hardware to facilitate data input to and output from computing environment 100 via a network 140, such as to weighted problem graph 130 when wholly or partially remotely stored. Network 140 is, for example, a data network, the Internet, a wide area network (WAN) or a local area (LAN) network. Network 140 serves as a communication medium to various remote devices (e.g., databases, web servers, remote servers, application servers, intermediary servers, client machines, other portable devices).

The memory 112 includes a dynamical Ising solver 102 that includes modules that operate in concert and/or stages to generate a solution to a combinatorial optimization problem corresponding to weighted problem graph 104.

Problem characterization module 118 receives a problem graph that includes a set of binary variables linked by a set of edges that represent binary couplings between the binary variables, along with a set of weights that indicate the strength of the binary couplings. In some examples, the problem characterization module 118 also receives an edge coloring of the problem graph that assigns colors to the edges of the problem graph such that at most one edge of a given color is connected to each node. In other examples, the problem characterization module 118 generates an edge coloring of the problem graph via a polynomial time heuristic (e.g., the Misra and Gries edge coloring algorithm, etc.). The problem graph and the set of weights define a binary optimization problem (e.g., an Ising problem). In many examples, the binary optimization problem corresponds to a real-world problem such that a solution to the binary optimization problem is equivalent to a solution of the real-world problem (e.g., for a spin glass, a solution that maximizes a cut value on the equivalent Ising problem corresponds to a minimum energy solution of the spin glass, etc.).

Problem characterization module 118 also initializes the problem for the iterative solver module 120 and the perturbation module 122. In various examples, initializing the problem includes setting an initial step size and step size schedule for the iterative solver module 120, defining a set of continuous variables on a periodic range that correspond to the set of binary variables, and setting the set of continuous variables to random initial values.

Additionally, when the iterative solver module 120 and the perturbation module 122 generate a solution to the relaxed problem involving the set of continuous variables, the problem characterization module 118 reduces the final values of the set of continuous variables to binary values for the set of binary variables and outputs a binary solution indicating the binary values for the set of binary variables. In many examples, the binary solution is equivalent to a solution of a corresponding real-world problem (e.g., a low energy state of a spin glass, a solution to a logistics problem, etc.).

The iterative solver module 120 performs a set of sweeps of the set of edges, updating the values of the continuous variables. In each sweep, the iterative solver module 120 updates subsets of the set of edges based on grouping edges by edge color until the entire set of edges is updated. For a given subset (edge color), the iterative solver module 120 adjusts the current values of the pair of continuous variables connected to each edge of that subset. The iterative solver module 120 adjusts the current values of a pair of continuous variables by determining a minimum phase difference (e.g., with a magnitude of 180 degrees or less) between the pair of continuous variables based on their current values, uses the sign of the phase difference to assign one current value to move in one direction (e.g., clockwise or counterclockwise if the periodic continuous variables are viewed on a ring, etc.) and the other current value to move in the other direction (e.g., counterclockwise or clockwise, respectively). The magnitude that the iterative solver module 120 adjusts the current values is based on the current step size and the coupling between the pair of continuous variables. Additionally, after each sweep, the iterative solver module 120 updates the current step size based on the step size schedule. Because each continuous variable is connected to at most one edge of a given edge color, in some examples, the sweeps performed by the iterative solver module 120 are highly parallelized, with different threads updating one or more edges of a given color in parallel.

The perturbation module 122 perturbs subsets of the set of continuous variables, adjusting the current values of those subsets stochastically, but in a way that retains interaction and pattern information. In various examples, perturbation module 122 performs perturbations based on a dual phase window shift, wherein the range of values is divided into four consecutive subranges (e.g., based on two lines through the center of a ring with randomly selected angles, which randomly defines minimum and maximum values for each of four subranges), two nonadjacent subranges are selected, and continuous variables with current values within the selected subranges are adjusted by a random amount (e.g., either in a random direction such that the random amount is randomly added or subtracted or in a preselected direction). In various examples, the size of the selected subranges is between 70 and 110 degrees, and the magnitude of the adjustment is 45 degrees or less.

Systems and methods discussed herein employ a fast, highly accurate approach to performing a specialized type of binary optimization. This approach is based on a relaxation of the Ising problem designed from the ground up, providing an alternative to solvers that use coupled oscillators and models such as the Kuramoto model. The discrete dynamical systems solver approach employed by systems and methods discussed herein builds on this bottom-up model, with specializations for sparse Ising problems. A prototype digital solver was implemented and tested using long-standing benchmark problems, and its performance was compared against three of the best sets of published results. The solution quality of the prototype was very high, setting some new records for a heuristic solver. The speedups in the prototype relative to conventional solvers in reaching given targets were significantly larger for the larger problems tested. Systems and methods discussed herein can solve real-world sparse problems representable as combinatorial optimization problems, as well as provide insights relevant to other problem types, solver paradigms and hardware platforms.

The solver employed herein leverages bottom-up collective behavior rather than the top-down programming of conventional solvers. While such bottom-up collective behavior has been applied in the use of artificial neural networks and machine learning, systems and methods discussed herein instead apply collective behavior to combinatorial optimization. With optimization tasks the problem graph and weights are given as part of the input (e.g., as weighted problem graph 104, etc.), and the task is often to find a very high-quality solution (e.g., a low energy configuration) as quickly and efficiently as possible. Most optimization techniques generally require the top-down development of intricate algorithms (whether exact, approximate, or heuristic), with few applications in which digital or analog dynamical systems are engineered with simple rules and harnessed to perform collective combinatorial optimization.

Binary optimization problems with sparse quadratic interactions such as Ising problems have applications in a wide range of fields including finding global energy minima of spin glasses (where spins exist in a lattice with regular connectivity and a random mix of attractive (ferromagnetic) and repulsive (anti-ferromagnetic) interactions) and solving other similar problems. Spin glasses are among the most difficult simple binary optimization problems (toroidal spin glasses are NP-hard) and frequently used for benchmarking.

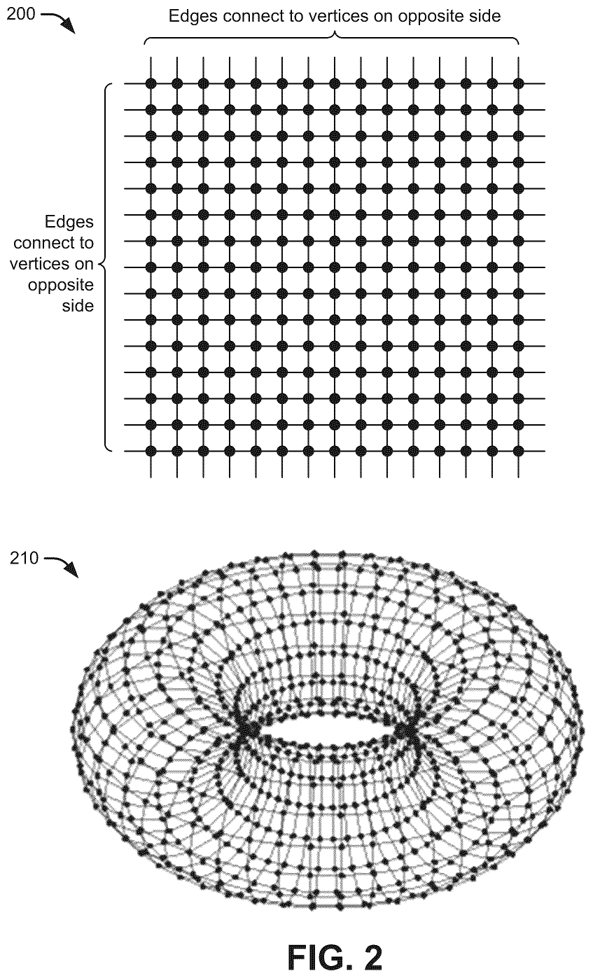

FIG. 2 illustrates a toroidal square grid graph shown as a square grid with periodic boundaries in both dimensions at 200 and as a torus 210 in a three-dimensional space (graph 200 and torus 210 have different dimensions). An Ising problem on a periodic square grid graph or torus is an NP (nondeterministic polynomial time)-hard problem. Dynamics with exclusively short-range interactions can be quite different in character than dynamics on complete graphs or small world graphs. For instance, due to long average path lengths, regional patterns can play a prominent role. Conventional solvers for Ising or quadratic unconstrained binary optimization (QUBO) problems are not geared toward handling regional patterns and are a poor fit even if they perform well on other graph types. Systems and methods discussed herein employ a specialized solver approach well suited to these types of problems.

There are three categories of solvers employed on combinatorial optimization problems: exact, approximate, and heuristic. Systems and methods discussed herein employ a heuristic solver that can rapidly generate highly accurate solutions, with efficiency gains relative to conventional solvers that increase as the problem complexity increases.

Exact solvers such as Gurobi and CPLEX can guarantee the optimality of solutions they find, and the scale of problem that can be solved exactly continues to improve. However, real-world applications often require finding solutions to large problems as quickly as possible even if not guaranteed to be exact. Approximation algorithms provide a theoretically guaranteed lower bound on accuracy, but the solution qualities tend to be far from optimal. A recent example approximation algorithm reached only about 94% of optimal on short-range spin glasses, significantly below the performance of systems and methods discussed herein.

With many applications in defense and commercial industry, there are significant advantages to being not only faster than the competition but more accurate. For example, achieving solution qualities above 99.9% of optimal might be required, depending on the application and on competitor capabilities. Attaining superior solution quality in a given time constraint is often highly advantageous; such application domains often have a winner-take-all character where even slightly higher solution quality than the competition is extremely valuable or decisive. Because of this, instead of approximation algorithms, real-world applications often employ heuristic algorithms which aim to provide the best trade of solution quality and computational effort without theoretical guarantees.

One conventional heuristic called Breakout Local Search (BLS) demonstrated unprecedented performance on short-range Ising problems in 2013 and is still used as a comparison point. A more recent approach is parallel tempering Monte Carlo which simulates replicas of a system at different temperatures and exchanges replicas across temperatures. A hardware-accelerated version of parallel tempering (PT) was implemented with an application-specific integrated circuit (ASIC) in the 2nd generation Fujitsu Digital Annealer (DA). A technique that can be combined with parallel tempering is replica cluster moves—two replicas at the same temperature are compared and a cluster of spins with the same pattern of satisfied/unsatisfied bonds is identified, after which the sign of the cluster is changed in each replica. Such moves randomize the configurations and can in some cases greatly accelerate simulations. Example move types are Houdayer moves and isoenergetic cluster moves (ICM). While the PT+ICM heuristic has shown leading performance among conventional techniques in certain cases, it relies on spin reversal symmetry and thus does not directly apply to problems that have local fields as many real-world problems do. Fujitsu has not made any reference to implementing ICM in its Digital Annealer. Hitachi has put forth a series of hardware-implemented simulated annealing-based solvers called complementary metal-oxide-semiconductor (CMOS) annealers that have short-range interactions (a King's graph lattice); unfortunately the solution qualities and extent of benchmarking results have been lacking. Toshiba introduced a novel heuristic called Simulated Bifurcation Machine (SBM) inspired by adiabatic evolution. There are myriad other ongoing efforts to implement Ising solvers using parallelizable heuristics, analog electronics, digital electronics, photonics, and other emerging hardware concepts. A recent survey of published efforts found that a Toshiba SBM implementation was the fastest of the conventional heuristics on fully connected spin glass problems. However, that survey did not compare performance on short-range Ising problems.

One approach to mathematical optimization is relaxation, in which certain problem constraints are relaxed, the relaxed problem is solved, and a solution to the original problem is generated. As one example, the binary constraints on spin variables in the Ising problem can be relaxed so that a modified problem with a continuous landscape can be defined. This can allow additional types of dynamics and solvers to be employed. Some models that have been pursued as potential Ising problem relaxations include the Kuramoto model of coupled oscillators, semidefinite programming (SDP) relaxations, the XY model, and the Simulated Bifurcation Machine. Systems and methods discussed herein employ an empirically informed, minimal, suitable relaxed problem defined from the ground up.

The energy function of Ising problems is given by the Hamiltonian H(s) of equation (1):

$$H ( s ) = - {\sum }_{〈 i , j 〉} {J}_{i j} {s}_{i} {s}_{j} - {\sum }_{i} {h}_{i} {s}_{i} \qquad ( 1 )$$

with spin variables sᵢ∈{−1, +1}, coupling weights Jᵢⱼ and local magnetic field strengths hᵢ. In equation (1), [symbol] i, j [symbol] refers to the set of all edges in the connectivity graph of the spin system. The relaxation involves defining a modified problem with continuous spin variables and an energy function that can facilitate finding solutions to the original problem.

One design choice in this relaxation is whether to define the variable range with fixed boundaries (with variables forbidden from moving beyond the edge of their defined interval) or periodic boundaries (with variables allowed to wrap around the edge of their defined interval). This question seems not to be addressed prominently in the dynamical Ising solver literature but impacts the dynamics that will be possible. One consideration for this decision is that achieving optimal or near-optimal energy may involve many variables changing state. Often in binary optimization a cluster of variables will tend to be polarized (with members at opposite values) due to repulsive couplings, and it can be energetically favorable to keep such members at opposite values. With fixed variable boundaries (e.g., on the interval [−1, 1], etc.), variables essentially range over a straight-line track, potentially making it difficult for repulsively-coupled variable pairs to swap positions. Depending on the model, the pairs often temporarily come close together in order to pass by, which may be energetically unfavorable. On the other hand, a periodic variable interval acts as a ring, making it far easier for a polarized cluster to flip; one subset rotates around half of the ring while the other rotates around the other half.

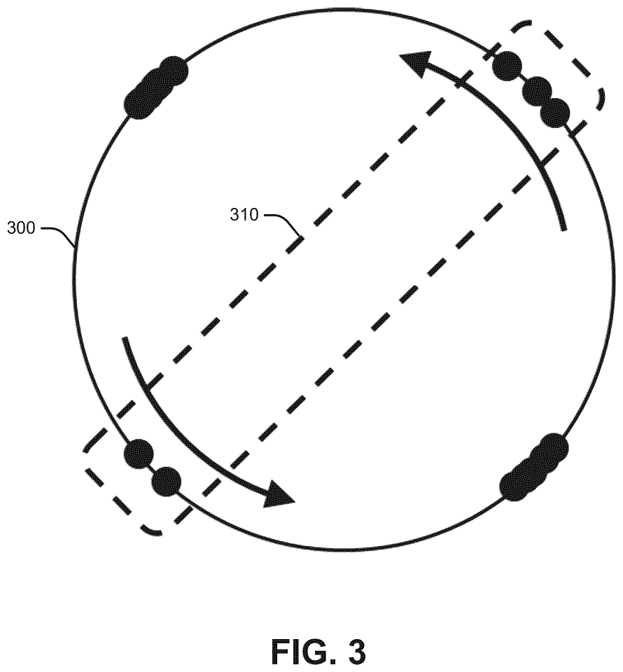

Referring to FIG. 3, illustrated is a diagram showing a periodic interval represented as a ring 300, with individual variables represented as black circles on the ring. As can be seen in FIG. 3, allowing variables to range over a periodic interval (a ring) can allow a large, polarized cluster (indicated within dashed rectangle 310) to flip in unison while maintaining anti-alignment of its two subsets of members. These polarized cluster flips have the potential to lower system energy.

Thus, a periodic interval allows the alignment and anti-alignment relationships among members of the cluster (e.g., determined by systems and methods discussed herein) to remain intact and the intra-cluster bond energy to remain unchanged. Bonds at the interface of the cluster do change and thus the energy at the interface of the cluster can potentially decrease. Such moves are referred to herein as “polarized cluster flips.” While this is a heuristic argument, the potential to facilitate polarized cluster flips is one reason systems and methods discussed herein employ a periodic interval. Solvers discussed herein can employ continuous variables φᵢ defined with periodic boundaries on the interval [−180, 180], similar to models of phase oscillators, as a relaxation of the problem defined in connection with equation (1).

A second design choice is how to define the energy function of the relaxed problem. Systems and methods discussed herein retain the form of the Ising Hamiltonian (in equation (1)) but define a modified total energy function Eₜₒₜ with an energy function ƒ of two variables as in equation (2):

$${E}_{t o t} ( φ ) = - {\sum }_{〈 i , j 〉} {J}_{i j} f ( {φ}_{i} , {φ}_{j} ) - {\sum }_{i} {h}_{i} f ( {φ}_{i} , {φ}_{ref} ) \qquad ( 2 )$$

A dynamical systems approach that uses the gradient of a continuous energy function as a guide to minimizing energy is employed in defining the energy function ƒ. The energy function is defined such that the associated gradients are likely to be helpful in minimizing the original Hamiltonian of the unrelaxed problem in equation (1). The Kuramoto model, Rank-2 SDP, and XY model all contain bond energies proportional to Jᵢⱼ cos(φᵢ−φⱼ) and resulting gradient-based governing dynamics with terms Jᵢⱼ sin(φᵢ−φⱼ). However, the sine function is problematic for optimizing variable alignment/anti-alignment, since it has low magnitude when two phase variables are close to misalignment. For example, for two ferromagnetically coupled variables that happen to be separated in phase by nearly 180 degrees, sine evaluates to near 0 and thus the gradient will point only weakly in the corrective direction, allowing the misalignment to linger. The same is true of an anti-FM pair that is mistakenly in near alignment. Another reason for concern is that the sine function is quite inhomogeneous in magnitude; for most phase differences, the partial derivative terms making up the gradient will have uneven influence. A somewhat analogous issue of amplitude inhomogeneity has been identified in analog dynamical systems approaches; in that context, efforts have been made to modify the dynamics to correct for inhomogeneities. Instead of the sine function employed by many conventional solvers, systems and methods discussed herein employ a solver with an energy function designed from the start so that the associated coupling function used in the gradient has inherently homogenous magnitudes. In the Ising Hamiltonian (equation (1)), all bonds are essentially of equal importance modulated only by Jᵢⱼ; in equation (1), the magnitude of every sᵢsⱼ term is always 1. In other words, the total coupling energy in (1) is a sum of terms such as −J₁₂+J₁₃−J₂₃, where the coefficients (e.g., ±1) before the Jᵢⱼ terms have identical magnitude. Thus, the continuous energy function employed by systems and methods discussed herein is designed so that the gradient contains identically scaled Jᵢⱼ terms, irrespective of the relationship between φᵢ and φⱼ. Such an energy function has slopes of equal magnitude along every variable dimension, such that in each dimension it has a “v” shape.

The above design choices suggest an energy function ƒ that uses the absolute difference between two phases, as in equation (3):

$$f ( {φ}_{i} , {φ}_{j} ) = - \vert {φ}_{i} - {φ}_{j} \vert \qquad ( 3 )$$

Substituting equation (3) into equation (2) and setting φ_{ref} to 0 gives the modified energy function of equation (4):

$${E}_{t o t} ( φ ) = {\sum }_{〈 i , j 〉} {J}_{i j} \vert {φ}_{i} - {φ}_{j} \vert + {\sum }_{i} {h}_{i} \vert {φ}_{i} \vert \qquad ( 4 )$$

where the phase difference φᵢ−φⱼ is wrapped to the interval [−180, 180] and denotes the minimum angular difference. The energy landscape of a coupling takes on a simple “v” shape. As can be seen, the energy of a ferromagnetic (FM) coupling (Jᵢⱼ>0) is minimized only when the phase difference is near 0. Conversely, for an anti-FM coupling (Jᵢⱼ<0), energy is minimized only when the difference is near −180 or 180. By design, the magnitude of the slope is a constant at all points (other than exactly zero). A continuous dynamical system with equations of motion pointing in the direction opposite the gradient can be defined as in equations (5):

$$\frac{d}{d t} {φ}_{i} = - \frac{d {E}_{t o t} ( φ )}{d {φ}_{i}} , i = 1 , … , N \qquad ( 5 )$$

While equation (4) has a discontinuity at zero, a dynamical system using the sgn() (sign) function can be defined such that equations (5) become equations (6):

$$\frac{d}{d t} {φ}_{i} ( t ) = - α ( t ) ( {\sum }_{〈 i , j 〉} {J}_{i j} sgn ( {φ}_{i} ( t ) - {φ}_{j} ( t ) ) + {\sum }_{i} {h}_{i} sgn ( {φ}_{i} ( t ) ) ) , i = 1 , … , N \qquad ( 6 )$$

where α(t) is a scale factor and sgn(φ) is defined per equation (7):

$$sgn ( φ ) = \{ \begin{matrix}- 1 & if φ < 0 \\ 0 & if φ = 0 \\ 1 & if φ > 0\end{matrix} \qquad ( 7 )$$

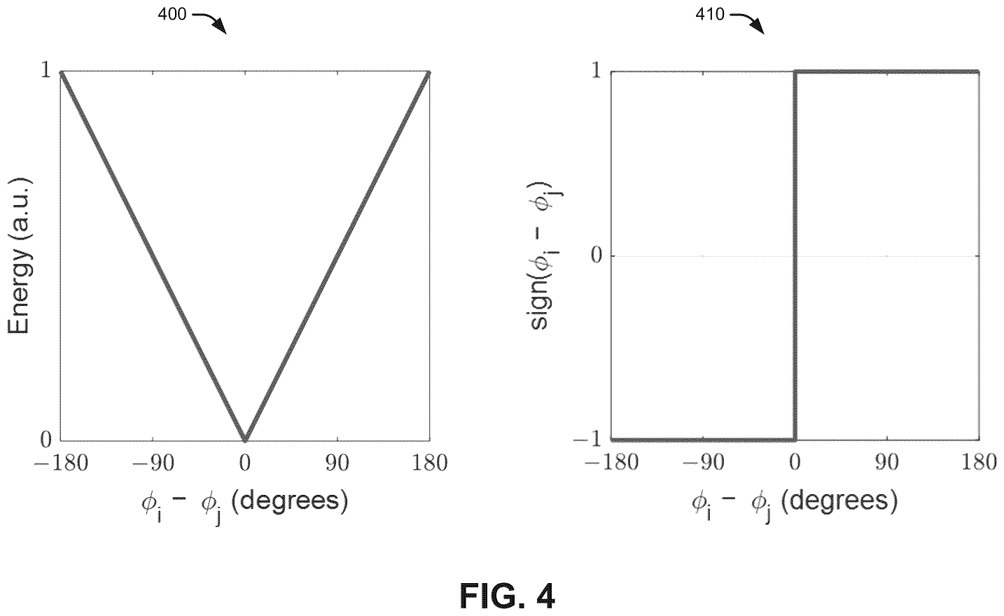

The sgn() function serves as the coupling function that defines how a variable changes in interaction with a neighbor; this is essentially a periodic step function with unit magnitude, meeting the design choice discussed above of scale factors that are identical for all couplings. The only exception is for an angle of exactly zero, which in practice can be made exceedingly rare (with random initial values, simulations of the prototype never encountered two coupled spin variables with exactly the same value). FIG. 4 illustrates a graph of the coupling energy as a function of angular difference at 400 and a graph of the coupling function as a function of angular difference at 410, for a pair of ferromagnetically coupled variables.

A model with periodic variables, a v-shaped energy function, and step-like coupling provides advantages, such as stronger coupling forces from small phase differences when compared to sinusoidal models, leading to faster synchronization, giving higher quality solutions quicker than sinusoidal models. The model of equations (2)-(7) can be implemented in continuous-time analog and discrete-time digital dynamical systems. Systems and methods discussed herein can employ digital implementations of dynamical solvers with specialized features tailored to certain problem types.

From the continuous model of equations (2)-(7), a discrete-time dynamical solver specialized for sparse Ising problems can be developed by discretizing equations (6) to get governing equations (8):

$${φ}_{i} ( k + 1 ) = {φ}_{i} ( k ) - α ( k ) ( {\sum }_{〈 i , j 〉} {J}_{i j} sgn ( {φ}_{i} ( k ) - {φ}_{j} ( k ) ) + {\sum }_{i} {h}_{i} sgn ( {φ}_{i} ( k ) ) ) , i = 1 , … , N \qquad ( 8 )$$

where α(k) is the step size. The step size can be held constant during the system evolution or can vary according to a schedule. For the prototype, a linear ramp from an initial value down to zero was found empirically to be effective. However, other examples can employ other (e.g., linear or nonlinear) schedules for step sizes that can vary from an initial value to a final value (e.g., zero or greater than zero). The resulting model with discrete interactions serves as a type of collective, pairwise bang-bang control. The binary switching of the coupling function using sgn() distinguishes it from conventional analog Ising solvers. This switch-based approach leads to dynamics that can be described as collective switched motion, abbreviated as Cosm.

With the presence of repulsive couplings, Cosm dynamics tend to naturally give rise to two main clusters of spins in anti-phase alignment. These main clusters are referred to herein as superclusters. By detecting the locations of the superclusters, a good (or even the best) partition of the variable interval into two halves is selectable, reducing each spin location to a single bit indicating the spin's preferred affiliation. The resulting bitstring represents a solution to the optimization problem. This natural tendency toward two superclusters is advantageous for binary optimization. In contrast, some conventional alternative approaches require external forcing of a two-cluster state using sub-harmonic injection locking, which introduces overhead and may indicate a limitation of the computational capabilities.

Systems and methods discussed herein perform updates of sub-neighborhoods (based on edge coloring) instead of full neighborhoods of interactions. As with many iterative methods, there is an inherent tradeoff regarding the step size α. Increasing the step size can speed up the dynamics but only to a point beyond which performance suffers. The Cosm approach includes a simple strategy for enabling larger than normal step sizes. Instead of evaluating all edges of the problem graph when updating the spin variables, only subsets are evaluated at once. Thus a larger step size can be used while still ensuring that variables do not move too far (overshoot). A fixed sequence of all edge subsets are evaluated in turn, for a full sweep of all edges. Empirically, this improves the dynamics. With most solvers, a spin variable update is a sum over a full neighborhood of interactions; the sub-neighborhood updates of Cosm are atypical in the optimization context.

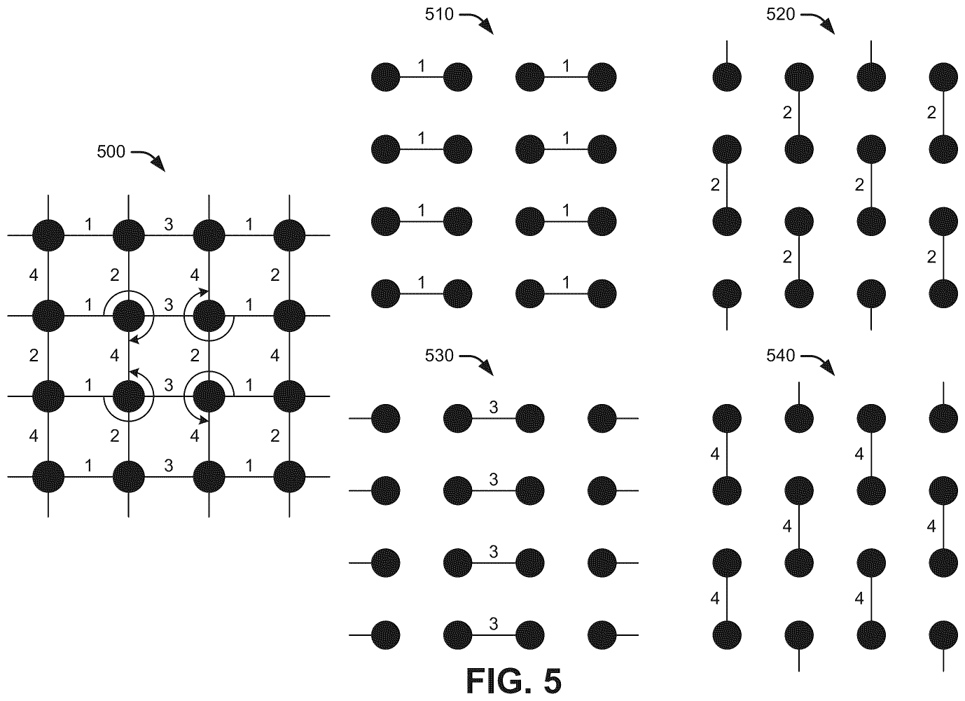

Sub-neighborhood updates have a loose connection to the notion of using subsets of training data for neural networks (stochastic grandient descent and mini-batch gradient descent), though here the edges are not selected randomly but according to a fixed schedule that corresponds to an edge coloring of the problem graph. An edge coloring is assigned to the edges of the problem graph (or in some examples, received with the weighted problem graph), where each node is connected to at most one edge of a given color. For square grid graphs with four nearest neighbors, an edge coloring with four colors can be employed, such that edges are evaluated one color at a time. FIG. 5 illustrates an example edge coloring 500 of a square grid with colors 1, 2, 3, and 4 along with the corresponding sub-neighborhoods 510-540 for sequential updates. The edge coloring 500 is an optimal edge coloring (using the minimum number of edge colors) of a square grid; an optimal coloring uses a number of edge colors equal to either the maximum degree of the graph (the maximum number of edges connected to a node) or one more than the maximum degree of the graph. Systems and methods discussed herein are employable with optimal or sub-optimal (e.g., using more edge colors than the minimum) edge colorings.

The number of colors of an edge coloring (e.g., how close the coloring is to optimal) is a parameter that affects the accuracy and efficiency of a solution, such that fewer edge colors increases efficiency and decreases accuracy, while more edge colors increases accuracy and decreases efficiency. Empirically, edge colorings within two to three of optimal have been found not to noticeably affect efficiency. Additionally, systems and methods discussed herein are orders of magnitude faster than conventional systems for higher complexity problems, such that the number of edge colors can deviate significantly from optimal while still providing a solution more efficiently than conventional systems.

Systems and methods discussed herein also employ techniques that facilitate high-quality cluster flips that improve solution accuracy. Short-range problems can exhibit strong spatial correlations, such as regions of the problem graph within which variables tend to move together. Achieving superior solution quality sometimes involves entire clusters changing polarity.

Various techniques exist to facilitate cluster flips, and the quality of the cluster flips also varies. One conventional method generates candidate clusters blindly using a model of avalanches and self-organized criticality, then imposes these on the spin system. Another conventional method is isoenergetic cluster moves, which simulates two replicas and identifies a large cluster of spins with a correlated pattern of bonds across the replicas. If the same pattern has evolved twice, it is taken as an indication that the pattern is desirable; the entire cluster is flipped together, maintaining the pattern. These moves are quite effective in some cases, when no local fields are present.

In contrast to conventional techniques, systems and methods discussed herein allow high-quality clusters to emerge naturally and flip if energetically favorable. The model derived herein allows for polarized cluster flips with its periodic interval (e.g., ring 300). However, gradient-based methods depend on being able to accurately calculate or sense the gradient, which is not always trivial. With the bang-bang interactions and large step sizes of Cosm, there can be a significant amount of dynamical fluctuation in spin positions. This acts as chatter (a concept long observed in bang-bang control and sliding mode control) and can cause a spin to be misguided when sampling the positions of neighbors. This can cause the collective gradient sensing performed by the system to have some inaccuracy, preventing the system from detecting a subtle gradient that would lead to improved energy. This factor seems to be present with toroidal spin glass problems.

However, systems and methods discussed herein employ a specialized technique that clears the way for more accurate gradient sensing. Groups of spins are selected at random and shifted together. In some examples the shifts are executed at regular intervals, while in other examples the shifts are executed at irregular intervals. The inclusion of shifts of groups of spins reduces the effect of chatter and stimulates the emergence of cluster flips. Stochasticity is known to be beneficial in the context of stochastic gradient descent and some oscillator-based solvers; by including these shifts of groups of spins there is stochasticity in spin group selection but also correlated motion of spins in the selected groups. The stimulated emergent cluster flips help drive the system energy toward optimality.

An example implementation of the Cosm heuristic employed by systems and methods is specified with the pseudocode in Table 1:

TABLE 1
Pseudocode of example Cosm implementation
Heuristic algorithm 1: Cosm

| | |
|---|---|
| 1: | Load input graph with pre-defined edge subsets |
| 2: | Set phases, α to initial values |
| 3: | for sweep = 1 to numSweeps do |
| 4: | for each subset of edges do |
| 5: | for each edge in subset do |
| 6: | Calculate minimum phase difference of the two spins |
| 7: | Use sign of phase difference to assign one spin to move clockwise and the |
| | other counterclockwise |
| 8: | Update spin positions by αJᵢⱼ in assigned directions |
| 9: | } |
| 10: | Apply dual phase window shift according to desired recipe |
| 11: | } |
| 12: | Update α according to desired schedule |
| 13: | } |
| 14: | Reduce final positions to binary values |
| 15: | Return binary solution |

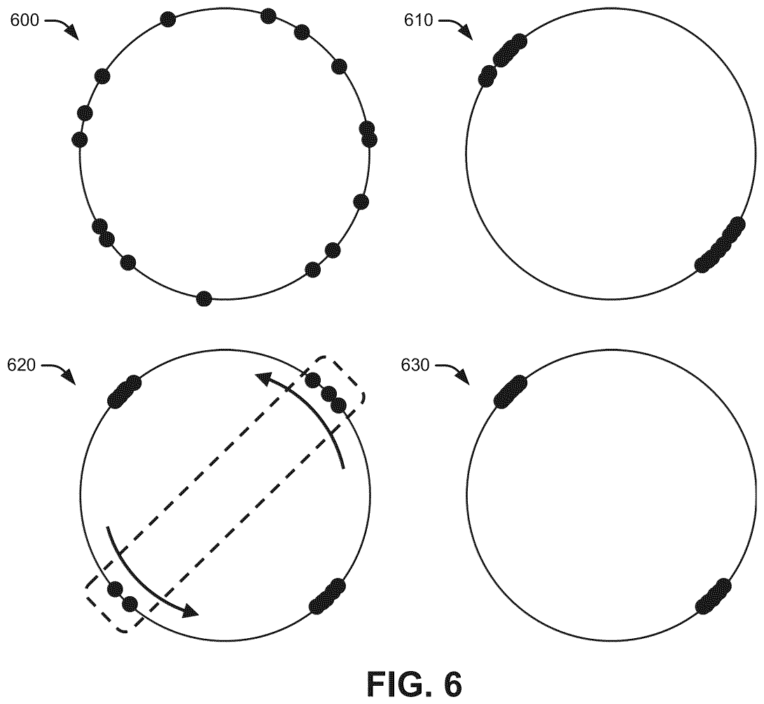

Referring to FIG. 6, illustrated are a series of four images 600-630 showing example dynamics of the Cosm solver discovering an extremely low-energy configuration through a polarized cluster flip. Spins (represented by the 16 black dots in FIG. 6) are initially assigned random positions along a unit circle, as shown at 600. After multiple iterations, two superclusters form, as shown at 610. Subsequently, clusters of spins tend to sense even subtle gradients and emerge and rotate together, driving toward lower energy. As mentioned above, the emergence of cluster flips is enhanced by the stimulation provided by dual phase window shifts. At 620, 5 spins that are clustered together in the problem graph emerge due to unsatisfied bonds outweighing satisfied bonds at the interface of the cluster, and the 5 spins (in the dashed rectangle) are rotated together to change affiliations. Finally, at 630, after the cluster move of 620, the system has descended to lower energy, after which a new cluster can emerge and the process continues.

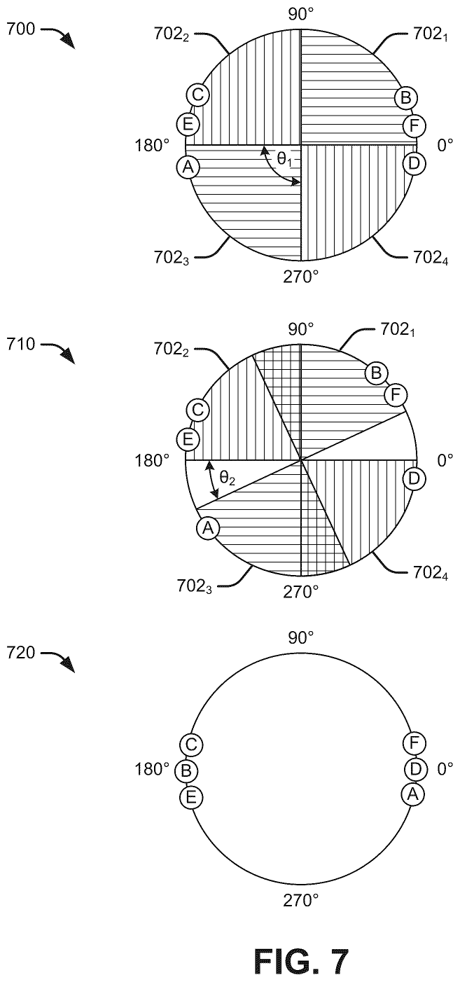

In some examples, polarized cluster flips are generated via dual phase window shifts. Referring to FIG. 7, illustrated are three images 700-720 showing a dual phase window shift used in some example systems and methods to generate polarized cluster flips. In the example shown in FIG. 7, six variables (A, B, C, D, E, and F) are shown, each with a value between 0 and 360 degrees, as shown by the position of the circles with the letters A-F. At the beginning, in image 700, the variables are segregated into two clusters, with variables {A,C,E} near 180 degrees and variables {B,D,F} near 0 degrees.

At the start of each dual phase window shift, shown at 700, the circle is divided into four new windows (slices). In some examples, the orientation of the set of windows is selected randomly (e.g., based on a randomly selected angle, etc.). In other examples, more sophisticated (allowing increased accuracy in exchange for efficiency) ways to select an orientation are applied, such as determining the values of variables and selecting based on that determination. In some examples, the size of the windows (θ₁ and 180°-θ₁ in 700) are all 90°, while in other examples the sizes of the windows are randomly selected, with opposite slices having equal size and the total size equaling 360°. In various examples, the window size is close to 90°, such as 70-110°.

At 710, two opposing windows (and any variables within the windows) get shifted (by angle θ₂ in 710). In some examples the size of the shift is constant during a run of the algorithm, while in other examples the size of the shift varies, such as by following some dynamic schedule during the algorithm. In some examples (e.g., in the prototype, where the windows were all 90 degrees wide), the shift is always in the same direction (e.g., clockwise or counterclockwise). In other examples (e.g., where the windows are not all 90 degrees, or in some examples where the windows are all 90 degrees wide), the direction of the shift is randomly chosen between clockwise or counterclockwise each time a dual phase window shift is performed. The magnitude of the shift is less than 90° and in some examples is less than or equal to 45°.

At 720, after the shift of 710 completed, variables A and B were freed up and eventually moved all the way to the opposite cluster (a 2-variable move), leading to a lower energy configuration, which is a higher quality solution. Though variable F incurred a shift at 720, it subsequently returned to the cluster near 0 degrees.

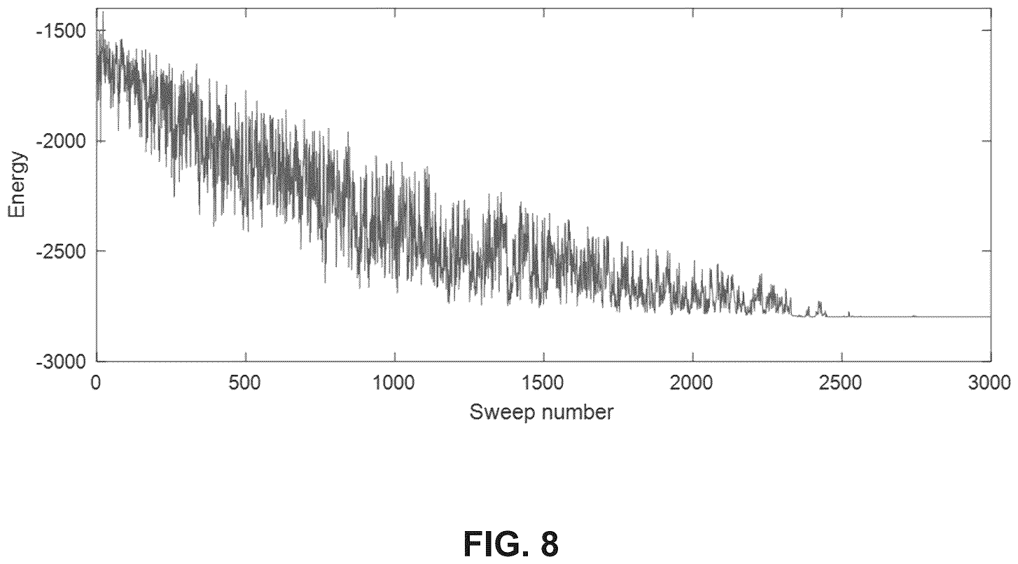

FIG. 8 shows an example of the energy evolution of a Cosm run as a function of sweep number. The solved problem of FIG. 8 had 2000 variables and a toroidal square grid, with a step size schedule that was a linear ramp to zero. While the energy fluctuated during much of the run, the final energy matched the best-known value. With Cosm, energy is quite often the lowest at the very end. Therefore, unlike some conventional solver approaches that need to read out and evaluate intermediate solutions in a search for the lowest, a readout at the end provides the lowest energy solution for systems and methods discussed herein.

In contrast to conventional solvers, the Cosm techniques of systems and methods discussed herein harness collective motion and emergent behavior for optimization, providing high quality solutions with an efficiency greater than conventional systems on complex problems, and efficiency gains that increase with problem complexity.

A prototype example (referred to herein as Cosm v1) was implemented in MATLAB paired with a laptop CPU. Performance was tested on the long-standing, sparse benchmark problems from the Gset MaxCut suite, ranging from 8000 to 20,000 variables. These problems are NP-hard and have been attacked extensively since the year 2000. Wall clock time-to-target (TTT) was characterized for solution qualities matching a leading solver for which benchmark results are available—the Toshiba Simulated Bifurcation Machine (the dSB version running on a GPU). The Cosm v1 speedup is the ratio of the competing TTT vs. Cosm v1 TTT.

TTT represents the wall clock time to reach a cut greater than or equal to the specified target cut value with at least 99% probability, and is estimated using equation (9):

$$TTT ( target ) = execution time \frac{log ( 1 - . 99 )}{log ( 1 - {P}_{s} )} \qquad ( 9 )$$

Where Pₛ represents the success probability across multiple trials.

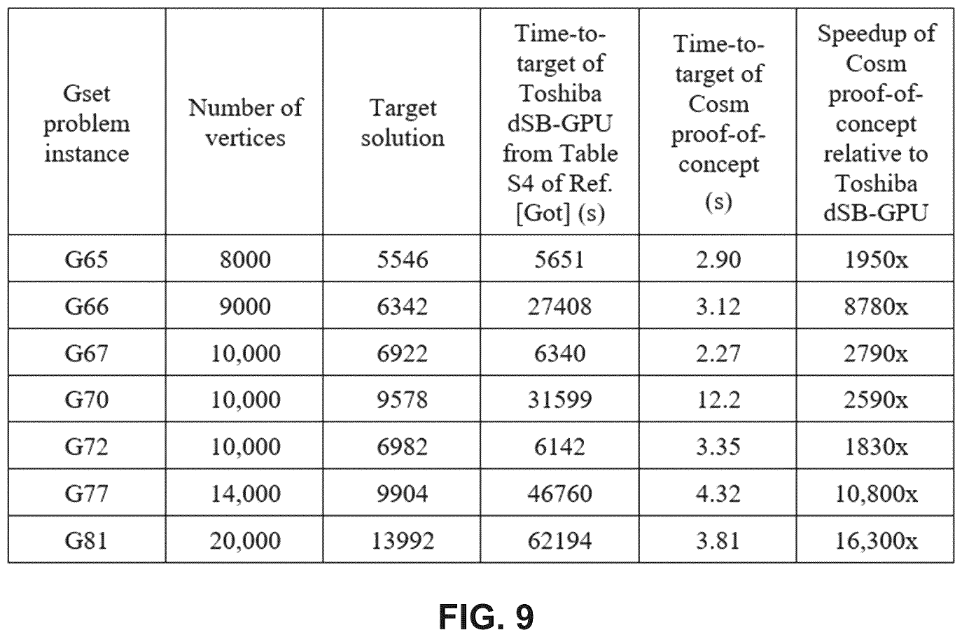

FIG. 9 shows a table of prototype Cosm solver results indicating the speed advantage relative to a leading commercial solver. On the seven largest sparse Ising problems from the long-standing Gset benchmarks, the prototype solver was three to four orders of magnitude faster in reaching the same target solution quality. Additionally, the prototype solver used a laptop CPU with a thermal design power of 45 W, while the Toshiba implementation used a GPU (Tesla V100) with a thermal design power of 300 W.

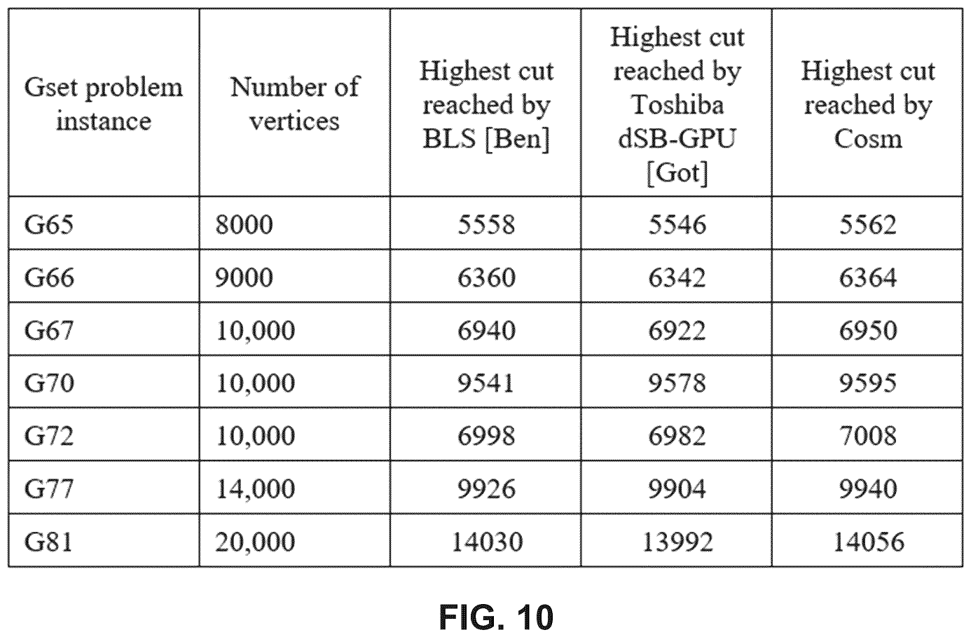

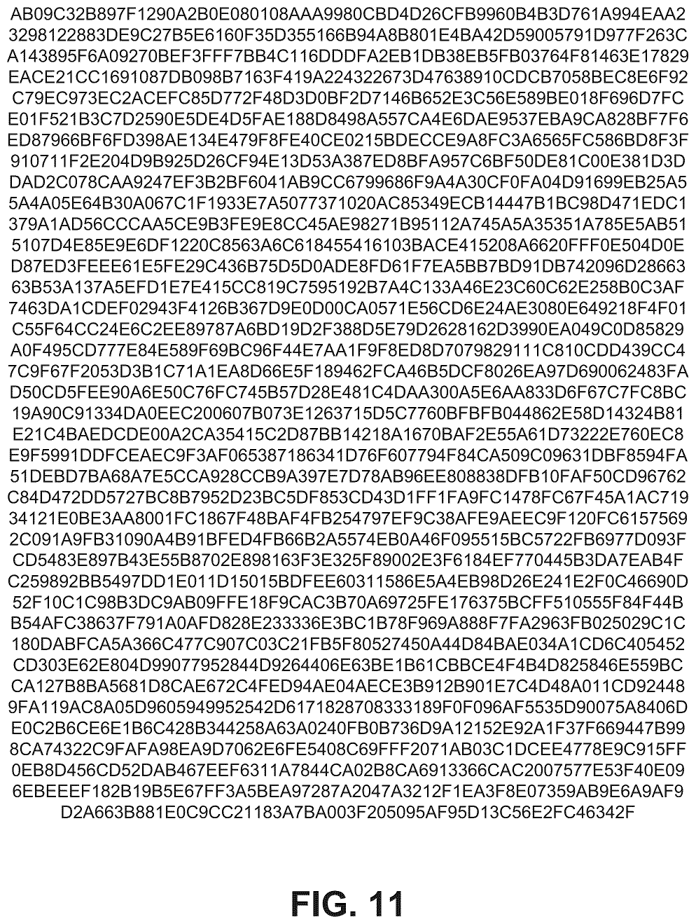

An additional metric for comparing heuristic performance is the peak solution quality achieved. FIG. 10 shows a table of solution quality for the Cosm v1 prototype compared to two leading conventional solvers. Cosm reached unsurpassed levels of solution quality, as shown in FIG. 10. No known heuristic solver has previously matched these best-known solutions on these benchmark problems, which have been attacked by a wide range of approaches since the year 2000. Moreover, for two instances (G72 and G77), the prototype reached cuts that were higher than those previously reported to be the best known. FIG. 11 shows a solution bitstring for the Gset G72 problem generated by the prototype with a cut value (7008) higher than the previous best reported cut (7006). The hexadecimal string of FIG. 11 is expandable to binary values representing variables 1 to 10,000 from left to right. The cut value can be calculated using the G72 problem instance definition and the standard MaxCut objective function.

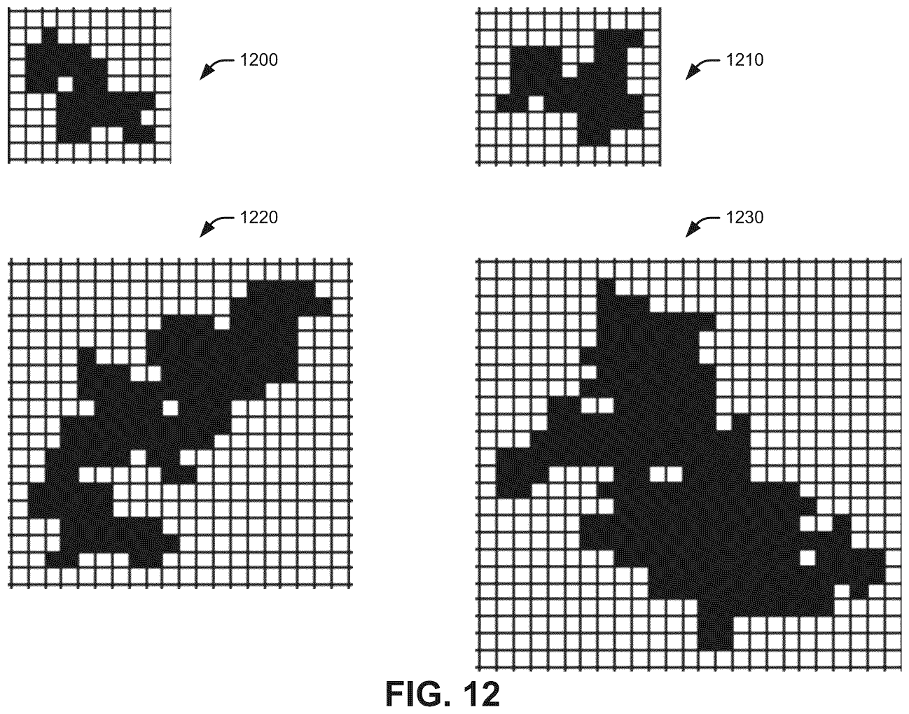

Several of the prototype runs were analyzed in detail to gain insight into how Cosm went beyond a cut of 7006 on the G72 instance and reached a record cut of 7008. In some cases, there were multiple clusters that flipped. In four cases, there was a single cluster flip responsible for reaching the best cut. The size of each of the four cluster flips was quite large: 29, 35, 122 and 204 variables. FIG. 12 illustrates the spatial layout of the four larger cluster flips responsible for reaching the best cut. The size 29 cluster is at 1200, the size 35 cluster is at 1210, the size 122 cluster is at 1220, and the size 204 cluster is at 1230. The largest of these clusters represents over 2% of all variables on the 100×100 grid. In the size 204 cluster there are 128 bonds at the interface of the cluster. Before the flip 63 of the 128 bonds were satisfied, and after the flip 65 were satisfied, improving the cut by 2. This cluster flip illustrates how systems and methods discussed herein sense even subtle gradients, allowing a cluster to emerge and flip to lower the interface energy and thus lower system energy.

Systems and methods discussed herein heuristically solve sparse Ising problems including toroidal spin glasses quickly and with extremely high quality, based on emergent cluster flips, facilitated by the use of periodic variables, collective bang-bang interactions, and a specialized method (dual phase window shifts) of freeing up spins to better sense subtle gradients.

While the prototype was implemented in MATLAB with the CPU of the laptop used for the prototype, additional efficiency gains (e.g., of 10 times or more) are achievable through a high-performance software implementation (e.g., in C++) even in the same computing environment. Additionally, Cosm is designed for massive parallelization and highly efficient digital Ising accelerators are achievable with different hardware (e.g., using GPUs, FPGAs, etc.). The prototype used very little parallelization (6 threads) and carried the overhead of MATLAB. Digital accelerator implementations are expected to provide additional speedups (e.g., of 1000 times or more) relative to the prototype. Additionally, some examples use Cosm as a kernel and employ techniques for smart feedback during solver runs, adaptive schedules, etc.

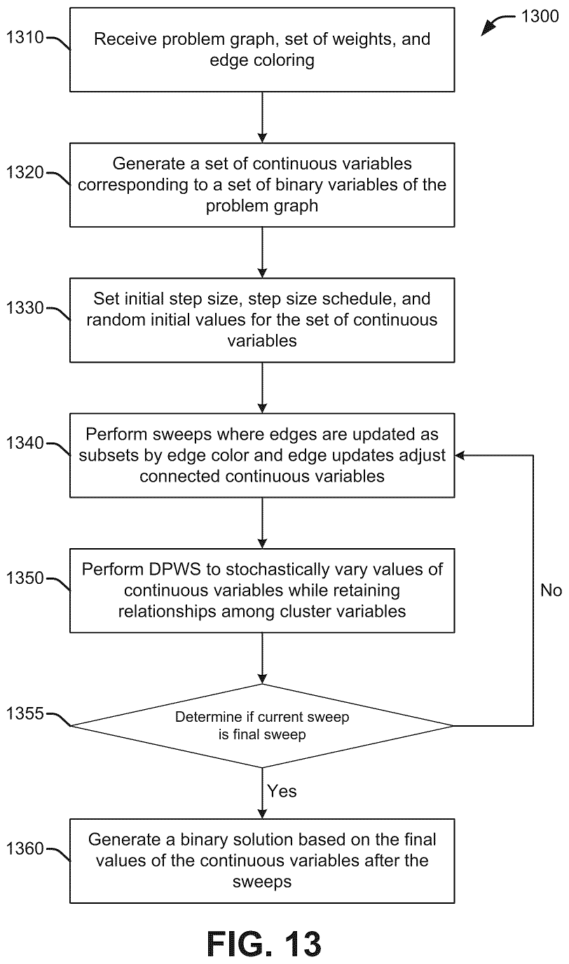

In view of the foregoing structural and functional features described above, an example method will be better appreciated with reference to FIG. 13. While, for purposes of simplicity of explanation, the example method of FIG. 13 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method.

FIG. 13 illustrates a flowchart of an example method 1300 for using a dynamical Ising solver system (e.g., dynamical Ising solver 102 of FIG. 1) to efficiently generate high-quality solutions of binary optimization problems. In other examples, the blocks of example method 1100 are a set of machine-readable instructions on a non-transitory machine-readable medium or are a set of operations performed by a processor executing machine-readable instructions as the operations.

At block 1310, method 1300 includes receiving a binary optimization problem as a problem graph that includes a set of binary variables connected by a set of edges indicating couplings, a set of weights for the set of edges, and an edge coloring. In some examples, the edge coloring is received as a predetermined edge coloring. In other examples, the edge coloring is received via a module that determines a sufficient edge coloring via a polynomial-time heuristic. The edge coloring indicates an edge color for each edge of the problem graph such that each binary variable is connected to at most one edge of a given color.

At block 1320, method 1300 includes generating a set of continuous variables that correspond to the set of binary variables of the problem graph. The set of continuous variables are periodic variables.

At block 1330, method 1300 includes setting an initial step size, a step size schedule (e.g., linearly decreasing, etc.), and random initial values for the set of continuous variables.

At block 1340, method 1300 includes performing a set of sweeps. Each sweep involves updating the current values of the continuous variables based on subsets of edges defined by the edge colors. For a given subset of edges (edge color), for edges of that edge color, the continuous variables connected to that edge are updated by determining their minimum phase difference, determining directions each continuous variable changes, and changing the current values of those continuous variables based on the step size and the coupling between those continuous variables. After each sweep, the current step size is updated based on the step size schedule.

At block 1350, method 1300 includes performing on the set of continuous variables by selecting a cluster or subset of the variables to vary values of (e.g., to escape local but non-global minima, etc.) while retaining alignment and anti-alignment relationships among the cluster. In various examples, dual phase window shifts are used to foster cluster flips, such that a random angle is selected to divide the range of the continuous variables into four subranges, and two nonadjacent subranges are rotated to change the values of continuous variables in those subranges by a random amount. Cluster flips are stimulated at random or fixed intervals, such as every sweep, every two sweeps, every 2.5 sweeps, etc.

At block 1355, method 1300 includes determining whether the most recently performed sweep is the last sweep (e.g., based on a predetermined number of sweeps, etc.). When the most recently performed sweep is not the last sweep, blocks 1340-1355 are repeated. When the most recently performed sweep is the last sweep, a binary solution is generated at block 1360.

At block 1360, method 1300 includes generating a binary solution based on the final values of the continuous variables after the set of sweeps. The binary solution includes a set of binary values for the set of binary variables. The set of binary variables are determined based on reducing the final values of the continuous variables (which have formed two superclusters after multiple sweeps) to binary values.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Also as used herein, the term “set” means one or more elements (e.g., where the elements can be anything, such as datasets, nodes, relationships, etc.), and a “subset” of a set A refers to any set B where every element of set B is an element of set A (note that every set A is a subset of itself, as every element of set A is an element of set A). Additionally, where the disclosure or claims recite “a,” “an,” “a first,” or “another” element, or the equivalent thereof, it should be interpreted to include one or more than one such element, neither requiring nor excluding two or more such elements.

In this description, unless otherwise stated, “about,” “approximately” or “substantially” preceding a parameter means being within +/−10 percent of that parameter. Modifications are possible in the described embodiments, and other embodiments are possible, within the scope of the claims.

What is claimed is:

1. A non-transitory machine-readable medium having machine executable instructions for a dynamical Ising solver that cause a processor core to execute operations, the operations comprising:
receiving a problem graph comprising a set of binary variables connected by a set of edges, a set of weights associated with the set of edges, and an edge coloring of the set of edges that indicates an edge color of a set of edge colors for an edge of the set of edges, wherein the edge of the set of edges corresponds to a pairwise coupling between the binary variables connected by the edge, a weight of the set of weights indicates a coupling strength of the edge of the set of edges, and the binary variable of the set of binary variables is connected to at most one edge of the set of edges with the edge color of the set of edge colors;
generating a set of continuous variables, wherein a continuous variable of the set of continuous variables corresponds to the binary variable of the set of binary variables;
setting a current step size to an initial step size and a current value of the continuous variable of the set of continuous variables to a random initial value;
performing a sweep of a set of sweeps, the sweep comprising:
updating a subset of the set of edges, wherein the subset comprises edges with a given edge color, wherein updating the subset of the set of edges comprises, for a given edge of the subset, adjusting the current values of the continuous variables connected to the given edge based on a minimum phase difference between the current values, the current step size, and the coupling strength of the given edge;
performing a dual phase window shift on the set of continuous variables; and
updating the current step size based on a step size schedule; and
generating a binary solution for the problem graph and the set of weights, wherein the binary solution comprises a set of final values for the set of binary variables based on the current values of the set of continuous variables.

2. The non-transitory machine-readable medium of claim 1, wherein the problem graph and the set of weights correspond to a spin glass, and the binary solution is a low energy state of the spin glass.

3. The non-transitory machine-readable medium of claim 1, wherein the continuous variable of the set of continuous variables is a periodic variable.

4. The non-transitory machine-readable medium of claim 1, wherein the step size schedule linearly decreases from an initial step size to a final step size.

5. The non-transitory machine-readable medium of claim 1, wherein adjusting the current values of the continuous variables comprises changing the current values by an adjustment amount that has a magnitude proportional to the current step size in a clockwise direction for one current value of the current values and in a counterclockwise direction for the other current value of the current values.

6. The non-transitory machine-readable medium of claim 1, wherein performing the dual phase window shift comprises:
dividing a range of the set of continuous variables into four consecutive subranges;
selecting a pair of nonadjacent subranges of the four consecutive subranges, wherein a first subset of the set of continuous variables has current values in the pair of nonadjacent subranges; and
adjusting the current values of the first subset of the set of continuous variables by a common value.

7. The non-transitory machine-readable medium of claim 6, wherein a first difference between a first maximum value of a first subrange of the pair of nonadjacent subranges and a first minimum value of the first subrange is equal to a second difference between a second maximum value of a second subrange of the pair of nonadjacent subranges and a second minimum value of the second subrange.

8. The non-transitory machine-readable medium of claim 7, wherein the first difference is between 70/360 and 110/360 of the difference between a maximum value of the range of the set of continuous variables and a minimum value of the range of the set of continuous variables.

9. The non-transitory machine-readable medium of claim 7, wherein performing the dual phase window shift further comprises selecting the first maximum value and the first minimum value based on a random value.

10. A dynamical Ising solver system comprising:
a memory for storing machine-readable instructions; and
a processor core for accessing the machine-readable instructions and executing the machine-readable instructions as operations, the operations comprising:
receiving a problem graph comprising a set of binary variables connected by a set of edges, a set of weights associated with the set of edges, and an edge coloring of the set of edges that indicates an edge color of a set of edge colors for an edge of the set of edges, wherein the edge of the set of edges corresponds to a pairwise coupling between the binary variables connected by the edge, a weight of the set of weights indicates a coupling strength of the edge of the set of edges, and the binary variable of the set of binary variables is connected to at most one edge of the set of edges with the edge color of the set of edge colors;
generating a set of continuous variables, wherein a continuous variable of the set of continuous variables corresponds to the binary variable of the set of binary variables;
setting a current step size to an initial step size and a current value of the continuous variable of the set of continuous variables to a random initial value;
performing a sweep of a set of sweeps, the sweep comprising:
updating a subset of the set of edges, wherein the subset comprises edges with a given edge color, wherein updating the subset of the set of edges comprises, for a given edge of the subset, adjusting the current values of the continuous variables connected to the given edge based on a minimum phase difference between the current values, the current step size, and the coupling strength of the given edge;
performing a dual phase window shift on the set of continuous variables; and
updating the current step size based on a step size schedule; and
generating a binary solution for the problem graph and the set of weights, wherein the binary solution comprises a set of final values for the set of binary variables based on the current values of the set of continuous variables.

11. The dynamical Ising solver system of claim 10, wherein the problem graph and the set of weights correspond to a spin glass, and the binary solution is a low energy state of the spin glass.

12. The dynamical Ising solver system of claim 10, wherein performing the dual phase window shift comprises:
dividing a range of the set of continuous variables into four consecutive subranges;
selecting a pair of nonadjacent subranges of the four consecutive subranges, wherein a first subset of the set of continuous variables has current values in the pair of nonadjacent subranges; and
adjusting the current values of the first subset of the set of continuous variables by a common value.

13. The dynamical Ising solver system of claim 12, wherein the common value is less than or equal to 45/360 of the difference between a maximum value of the range of the set of continuous variables and a minimum value of the range of the set of continuous variables.

14. The dynamical Ising solver system of claim 10, further comprising generating the edge coloring via a polynomial-time heuristic.

15. A method for dynamically solving Ising problems, the method comprising:
receiving a problem graph comprising a set of binary variables connected by a set of edges, a set of weights associated with the set of edges, and an edge coloring of the set of edges that indicates an edge color of a set of edge colors for an edge of the set of edges, wherein the edge of the set of edges corresponds to a pairwise coupling between the binary variables connected by the edge, a weight of the set of weights indicates a coupling strength of the edge of the set of edges, and the binary variable of the set of binary variables is connected to at most one edge of the set of edges with the edge color of the set of edge colors;
generating a set of continuous variables, wherein a continuous variable of the set of continuous variables corresponds to the binary variable of the set of binary variables;
setting a current step size to an initial step size and a current value of the continuous variable of the set of continuous variables to a random initial value;
performing a sweep of a set of sweeps, the sweep comprising:
updating a subset of the set of edges, wherein the subset comprises edges with a given edge color, wherein updating the subset of the set of edges comprises, for a given edge of the subset, adjusting the current values of the continuous variables connected to the given edge based on a minimum phase difference between the current values, the current step size, and the coupling strength of the given edge;
performing a dual phase window shift on the set of continuous variables; and
updating the current step size based on a step size schedule; and
generating a binary solution for the problem graph and the set of weights, wherein the binary solution comprises a set of final values for the set of binary variables based on the current values of the set of continuous variables.

16. The method of claim 15, wherein the problem graph and the set of weights correspond to a spin glass, and the binary solution is a low energy state of the spin glass.

17. The method of claim 15, wherein the continuous variable of the set of continuous variables is a periodic variable.

18. The method of claim 15, wherein adjusting the current values of the continuous variables comprises changing the current values by an adjustment amount that has a magnitude proportional to the current step size in a clockwise direction for one current value of the current values and in a counterclockwise direction for the other current value of the current values.

19. The method of claim 15, wherein performing the dual phase window shift comprises:
dividing a range of the set of continuous variables into four consecutive subranges;
selecting a pair of nonadjacent subranges of the four consecutive subranges, wherein a first subset of the set of continuous variables has current values in the pair of nonadjacent subranges; and
adjusting the current values of the first subset of the set of continuous variables by a common value.

20. The method of claim 19, wherein adjusting the current values comprises randomly selecting between adding the common value to the current values of the first subset and subtracting the common value from the current values of the first subset.
